(19) United States
(12) Patent Application Publication
(10) Pub. No.: US 2011/0200793 A1
(43) Pub. Date: Aug. 18, 2011

(54) Method of dying and coating paper for printing

(76) Inventor: Jay Anthony Grinnell, McMurray, PA (US)

(21) Appl. No.: 12/931,806

(22) Filed: Feb. 12, 2011

Related U.S. Application Data
(60) Provisional application No. 61/338,191, filed on Feb. 16, 2010.

(51) Int. Cl. B32B 3/28; B32B 3/10; B29C 59/04; D21H 23/58; D21H 27/00; D21H 23/70; B32B 29/00

(52) U.S. Cl. 428/174; 428/211.1; 264/78; 8/445; 8/636; 428/537.5

(57) ABSTRACT

A first embodiment can be a method for dying both sides of a paper individually with the capability of different color on each side with a permanent color in the core. Either or both sides can also have one or more printings added. This embodiment can further have a removable coat added wherein the removable coat can be specifically formulated for removal by abrasion such as sanding onto the dyed paper. Further a varnish can be added to the removable coating. In an even further embodiment, printing such as using a CMYK or spot color can be added to the varnished removable coating. The paper can also be embossed with various designs in addition to or in alternative to the printing. The final product can have printed designs of any color combined with embossed designs or patterns. The printed or coated surface colors can be removed by abrasion so the top layer of color can be removed to reveal the color of the paper underneath or the first layer of printing.

### CROSS-REFERENCE TO RELATED APPLICATIONS

This application claims priority of Provisional Patent Application No. 61/338, 191 filed on Feb. 16, 2010.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BRIEF DESCRIPTION OF THE SEVERAL VIEWS OF THE DRAWING

FIG. 1 is a schematic of the dying, coating, and printing process.

### DETAILED DESCRIPTION OF THE INVENTION

A first embodiment can be a method for dying both sides of a paper individually with the capability of different color on each side with a permanent color in the core. Either or both sides can also have one or more printings added. This embodiment can further have a removable coat added wherein the removable coat can be specifically formulated for removal by abrasion such as sanding onto the dyed paper. Further a varnish can be added to the removable coating. In an even further embodiment, printing such as using a CMYK or spot color can be added to the varnished removable coating. The paper can also be embossed with various designs in addition to or in alternative to the printing. The final product can have printed designs of any color combined with embossed designs or patterns. The printed or coated surface colors can be removed by abrasion so the top layer of color can be removed to reveal the color of the paper underneath and any of the printings that have been added.

A first side of the paper can be dyed a first color. The paper to be dyed can range from about 120 gsm to about 300 gsm. The paper should be uncoated and un-calendared to achieve an even color with full dye penetration throughout the sheet. The first step in this embodiment can be placing the paper on an unwind stand of a gravure coating machine adapted for the method by the use of specifically designed coating rollers described below. The paper roll can be then unwound through a system of rollers on the gravure machine, one of which can contact a dye bath. The roller in contact with the dye bath has a screen patterned with about 90 to about 115 holes per centimeter ranging from about 0.25 mm to about 5 mm deep. A dye bath which can have dyes combined with propanol to facilitate the penetration of the dye into the paper can be contacted through the roller. After introduction of the dye bath the paper travels to a system of heaters to dry the paper. There can be one or more drying units in sequence and the drying temperature and the drying rate can be any effective such as about 100° C. at a rate of about 50 to about 70 meters per minute through the heaters. After drying the paper dyed on a single side.

The paper can be rewound for the dying of a second side. The dye color can match the first side or be a different color. The process for the second side can be exactly the same as the first so as to require no changes to the machinery. The paper roll can be then unwound through a system of rollers on the gravure machine, one of which can contact a dye bath. The roller in contact with the dye bath has a screen patterned with about 90 to about 115 holes per centimeter ranging from about 0.25 mm to about 5 mm deep. A dye bath which can have propanol to facilitate the penetration of the dye into the paper can be contacted through the roller. After introduction of the dye bath the paper travels to a system of heaters to dry the paper. An effective drying heat and drying rate can be used. The resulting product can have both sides completely dyed either a single color or two colors and a dyed interior with no white core. These sides can have one or more printings added by any standard method. The printings can be to a single or to both sides which can be hidden by subsequent layers and later be revealed by abrasion.

A removable coating can also be added to the dyed paper. The removable coating can be added to either side of the paper or both sides of the paper in the same machine and conditions as the dye. The removable coating can be specially formulated so as to form a highly opaque coating over the dyed paper to enable printing of any color, yet maintain the ability to be removed by abrasion. The removable coating can be comprised as follows:
903 Titanium: about 18%;
160 Titanium: about 12%;
Brightening agent: about 0.15%;
690 Resin: about 33%;
805 Resin: about 20%;
103 Resin: about 15%;
426 Leveling Agent: about 0.2%;
728 Dispersant-Humectant: about 0.5%;
523 Humectant: about 0.2%;
510 Defoamer: about 0.3%; and
Water: about 0.65%.
   In the above formulation the removable coating would be white in color, however, one skilled in the art could create a removable coating of any color desired by adding an appropriate dye or adding either CMYK or spot coloring to the varnish or both. Simultaneous to the removable coating being applied an aqueous coating can be applied to the opposite side to offset the surface tension created by the removable coating. A second removable coating could also be added to the other side. The removable coatings comprised as detailed in this application can be removed by abrasion techniques such as sanding or other normal coating removal techniques by a user to reveal the dyed color underneath.

After allowing the removable coating to dry a varnish can then be applied over the top of the coating. A varnish coating can be added in any standard method such as by a printing press or coating machine. A varnish coating can allow for limited ink adsorption and dot dispersion into the coating.

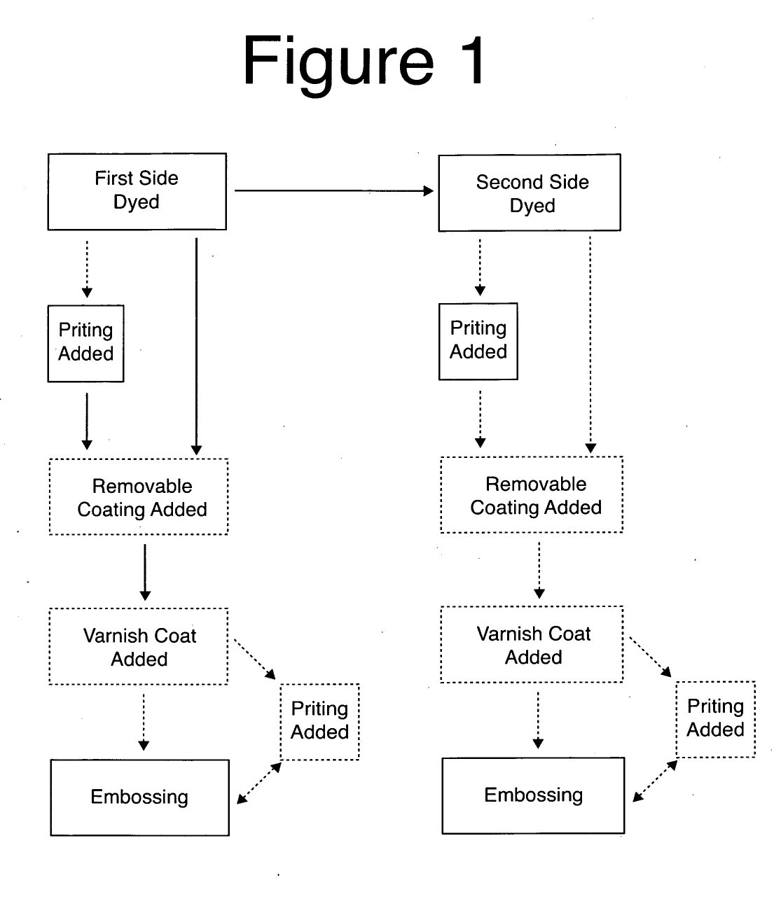

Subsequent to the removable coating and varnish, the paper can then undergo one or more prints. The removable coating allows the application of any color that can be applied using any printing method standard to one skilled in the art. Once can add any desired print, symbol, writing, or anything capable of print in any color including up to the entire page in one or more additional colors that can be removed by abrasion to reveal the dyed paper underneath. Additionally or alternatively the paper can be embossed by any standard method to give any desired pattern to the paper. See FIG. 1 where all broken lines indicate a layer that can be removed by abrasion to reveal the underneath layer represented by a continuous line box and all broken arrows represent possible, but not necessary, steps during which a user can stop at any point. The resulting product from all embodiments could be a double-sided printed paper that can have any desired areas of the printing and/or removable coating removed to reveal a color underneath on either or both sides where the paper is dyed down to the core. Further printing on the paper before the addition of the removable coating could have a printing that can be revealed after the removable coating is removed by abrasion.

These terms and specifications, including the examples, serve to describe the invention by example and not to limit the invention. It is expected that others will perceive differences, which, while differing from the forgoing, do not depart from the scope of the invention herein described and claimed. In particular, any of the function elements described herein may be replaced by any other known element having an equivalent function.

What is claimed is:

1. A paper comprising a first side, a second side, and a core wherein the core is permanently dyed a non-white color, the first side is dyed a color, and the second side can be dyed the same or a different color.

2. The paper of claim 1 further comprising one or more printings added to either the first or second side or both sides.

3. The paper of claim 1 further comprising adding a removable coating to either both sides or the first or second side wherein the removable coating is one that can be removed by abrasion.

4. The paper of claim 3 wherein the removable coating is further comprised of about 18% 903 titanium, about 12% 160 titanium, about 0.15% brightening agent, about 33% 690 resin, about 20% 805 resin, about 15% 103 resin, about 0.2% 426 leveling agent, about 0.5% 728 dispersant-humectant, about 0.2% 523 humectant, about 0.3% 510 defoamer, and about 0.65% water.

5. The paper of claim 4 wherein the removable coating has dye of preferred color added.

6. The paper of claim 3 further comprising a varnish added to the removable coating.

7. The paper of claim 6 further comprising one or more printings added to the varnish.

8. The paper of claim 6 further comprising adding one or more of CMYK or spot coloring to the varnish.

9. The paper of claim 6 further comprising adding embossing to the varnish coat.

10. The paper of claim 7 further comprising adding embossing to the varnish coat.

11. The paper of claim 8 further comprising adding embossing to the varnish coat.

12. A paper comprising a first side, a second side, and a core wherein the core is permanently dyed a non-white color, the first side is dyed a color, and the second side can be dyed the same or a different color wherein one or more printings can be added to either side, a removable coating that can be removed by abrasion can be added to either side, a varnish can be added to the removable coating, one or more printings can be added to the varnish, and embossing can be added to either side or both.

13. A method comprising dying a paper of about 120 gsm to about 300 gsm so that the core is permanently non-white wherein a first side of the paper is dyed, the second side of the paper is dyed the same or a different color wherein the paper is dyed by being unwound and placed on a gravure machine wherein the rollers are contact with the dye bath used to dye the paper have a screen patterned with about 90 to about 115 holes per centimeter from about 0.25 mm to about 5 mm deep.

14. The method of claim 13 further comprising adding one or more printings to either side or both sides of the paper.

15. The method of claim 13 further comprising adding a removable coating capable of removing by abrasion to either or both sides.

16. The method of claim 15 further comprising adding a varnish coating to the removable coating.

17. The method of claim 16 further comprising adding one or more prints the varnish coating.

18. The method of claim 13 further comprising adding embossing to either or both dyed sides.

19. The method of claim 15 further comprising adding embossing to the removable coating.

20. The method of claim 16 further comprising adding embossing to the varnish coating.
